(19) United States
(12) Patent Application Publication
(10) Pub. No.: US 2010/0250029 A1
(43) Pub. Date: Sep. 30, 2010

(54) DIGITAL SMART SERVO CONTROLLER FOR SAFETY CRITICAL VEHICLE CONTROL

(75) Inventors: Gerald Parras, Albuquerque, NM (US); David Scott Axtman, Albuquerque, NM (US)

Correspondence Address: HONEYWELL/S&S;Patent Services, 101 Columbia Road, P.O.Box 2245, Morristown, NJ, 07962-2245, US

(73) Assignee: Honeywell International Inc., Morristown, NJ (US)

(21) Appl. No.: 12/414,185

(22) Filed: Mar. 30, 2009

(51) Int. Cl. G05D 1/00; G05B 9/02

(52) U.S. Cl. 701/4; 244/195

(57) ABSTRACT

A smart servo controller that is operable to control a redundant configuration of servo motors corresponding to mechanical control surfaces of an aerial vehicle is described. The controller (i) outputs the necessary electrical signals that control the servo motors corresponding to each control surface, (ii) monitors those signals, (iii) monitors the positions of the servo motor shafts, and (iv) provides notification to a flight control computer upon detecting a servo malfunction.

### GOVERNMENT RIGHTS

The United States Government has acquired certain rights in this invention pursuant to Contract No. W56 HZV-05-C-0724, awarded by the U.S. Army Tank Automotive & Armaments Command.

### FIELD

The present invention relates to the control system of unmanned aerial vehicles, and more particularly to control systems with added safety and reliability through redundant control surface configurations.

### BACKGROUND

Unmanned Aerial Vehicles (UAVs) are autonomously or remotely piloted vehicles that are typically equipped with communications, surveillance equipment, or some other deliverable payload. UAVs are commonly used in situations where manned aerial vehicles are too costly, hazardous or otherwise unfeasible.

One such UAV is a ducted fan air vehicle and is described in commonly owned U.S. patent application Ser. No. 12/359,407, which is incorporated by reference herein in its entirety. As described in the above referenced application, a ducted fan air vehicle may have at least one ducted fan with blades and an engine to drive the fan. The rotation of the fan forces air down and through the duct providing lift to the vehicle. Mechanical control surfaces known as control vanes are located directly underneath the fan and provide maneuverability to the aircraft.

Traditional multi-airfoil element control vane sets on ducted fans usually operate in tandem, or together, and may be operated by only one servo. FIG. 1A illustrates a simplified ducted air vehicle 100 with eight control vanes. The vanes are set out in four pairs 101-104. Each vane in the pair has a separate servo motor controlling the pivot angle (or position) of the vane. FIG. 1B illustrates a side view of a control vane and the direction of pivot. The '407 application describes how the control of each vane by a separate servo motor, either alone or in tandem with its complement in a particular pair, operates to maneuver the air vehicle during flight. However, in the interest of safe and reliable control of the air vehicle, it would be desirable to provide a digital smart servo controller that can provide and monitor the functionally of the servo motors as well as provide notification to a flight control computer when a servo motor malfunction is detected.

### SUMMARY

In accordance with embodiments of the present invention, a servo controller works with a plurality of control vanes for a similar axis of control with separate servo motors controlling each vane in the plurality. If one servo motor in the plurality fails, the vehicle still has limited control with respect to that axis through the use of the remaining control vanes. Multiple courses of action exist in the event of a servo failure. For example, in some cases the flight computer can utilize the remaining control vane to maneuver the vehicle to a safe location in order to land, or abort the mission. In other cases, the flight can continue. In still other cases, the flight control computer can notify a human operator on the ground of the servo malfunction so that the operator can make a decision as to what course of action to take.

One object of the present invention is to provide a digital smart servo motor controller operable to (i) output electrical signals that control the servo motors corresponding to each control vane, (ii) monitor those signals, (iii) monitor the positions of the servo motor shafts, and (iv) provide notification to a flight control computer upon detecting a servo malfunction.

These as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible. For instance, structural elements and process steps can be rearranged, combined, distributed, eliminated, or otherwise changed, while remaining within the scope of the invention as claimed.

### BRIEF DESCRIPTION OF THE DRAWINGS

FIG. 1A illustrates a simplified ducted fan air vehicle.

FIG. 1B illustrates a side view of a control vane.

FIG. 2A and FIG. 2B illustrate the schematic of a smart servo motor controller according to an embodiment of the present invention.

FIG. 3 illustrates a pulse width modulated (PWM) signal.

FIG. 4 illustrates a method of controlling an air vehicle according to an embodiment of the present invention.

FIG. 5 illustrates a pre-flight built in test method according to an embodiment of the present invention.

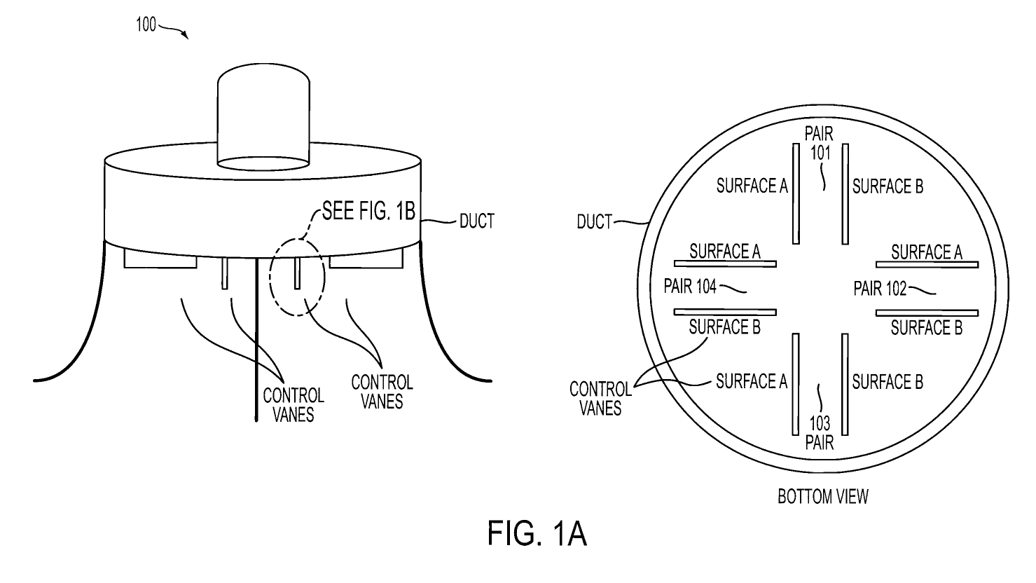

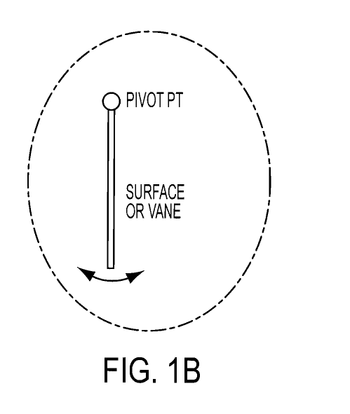

### DETAILED DESCRIPTION OF PRESENTLY PREFERRED EMBODIMENTS

The following detailed description sets forth a method and system for providing safe and reliable control for redundant servo motor configurations utilized in controlling mechanical control surfaces of unmanned aerial vehicles. The present invention will be described with respect to control vanes of a ducted air vehicle, but one skilled in the art would recognize that the present invention could easily apply to mechanical control surfaces of various other manned or unmanned air vehicles as well.

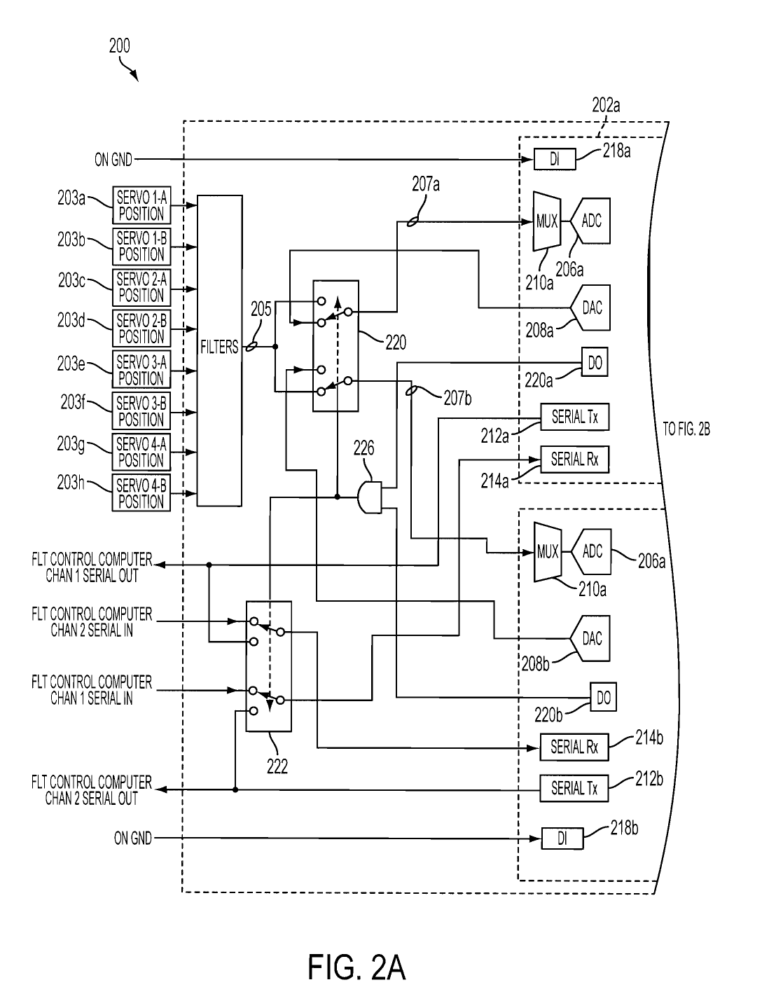

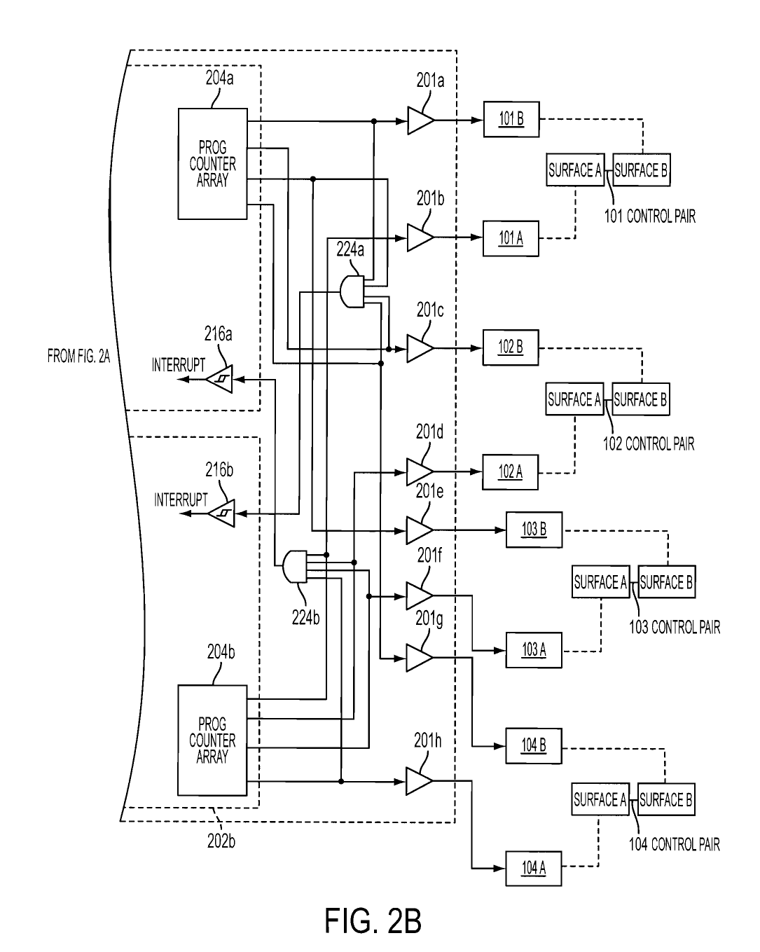

FIGS. 2A and 2B illustrate a controller 200 corresponding to ducted air vehicle 100, according to an embodiment of the present invention. Controller 200 comprises two microcontrollers 202a-b, logic gates, buffers, signal lines, switches, and filters. The preferred microcontroller has: at least one digital input, at least one digital output, an analog-to-digital converter, a digital-to-analog converter, a serial data output, a serial data input, at least one programmable counter array (PCA), at least one real-time interrupt input port, and program memory to store logic instructions. A digital input port may also function as the real-time interrupt port.

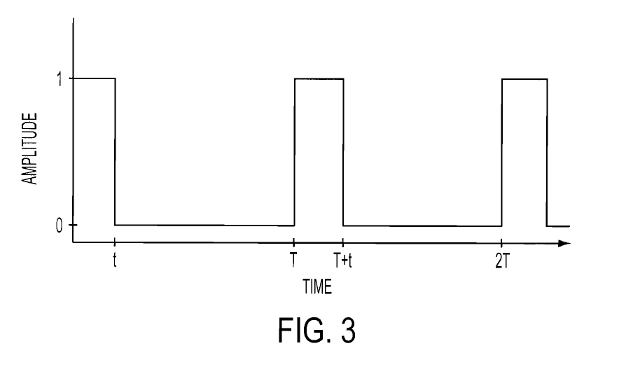

The PCAs 204a-b emit pulse width modulated (PWM) digital signals, such as the one illustrated in FIG. 3, that are sent along data lines to each servo motor. A duty cycle of the PWM signal can be defined by taking the ratio of the duration that the signal is asserted (i.e. logic high) (t) to the period of the signal (T). The servos change the angular position of the shaft in relation to the duty cycle of the received PWM signal. A typical servo motor shaft can rotate from 0° to 180° depending on the value of the duty cycle. For instance, a servo motor rated at 50 Hz expects a PWM signal with a period of 1/50 Hz or 20 ms. A duty cycle of 100% may rotate the shaft to the 180° position and would equate to the digital signal being asserted for all 20 ms of the period. A duty cycle of 50% may rotate the shaft to the 90° position and would equate to the digital signal being asserted for 10 ms of the 20 ms period. A duty cycle of 0% may rotate the shaft to the 0° position and would equate to the digital signal remaining unasserted for the length of the 20 ms period. Duty cycles in between the aforementioned values will rotate the shaft accordingly.

Other servo motors are operated by a maximum and minimum assertion time of the digital PWM signal. For example a particular servo could be rated at 50 Hz and rotate to 0° with a 1 ms (or less) pulse width and rotate to 180° with a 2 ms (or longer) pulse width. Therefore, for every 5.5 μs above 1 ms the pulse width is, the servo motor shaft will move one degree. These are intended as examples only as one skilled in the art would recognize that other duty cycle combinations, pulse widths, and period lengths could be substituted for the given examples to provide a similar effect.

One method of generating a PWM signal employs a PCA, typically utilized as a 16-bit counter that is able to count from 0 to 0FFFF hex (0FFFFH) and overflow back to 0. The counter clock period is selected to be less than the resolution of the digital servo. For example if the digital servo resolution is 0.5 microseconds the clock period may be selected to be 0.3 microseconds. The total count time, or frame, would be 0.3 microseconds multiplied by 0FFFFH (65535 decimal) equaling 19.66 milliseconds. The PCA is designed to assert the output high when the counter value becomes equal to a compare value; this yields the desired pulse width. For example, if the compare value is set to 0F000H, when the PCA reaches this value the output is asserted high. When the timer overflows past 0FFFFH the output is asserted back low thus creating the pulse width resulting from the difference between 0FFFFH and 0F000H. This difference results in a value of 0FFFH or 4095 decimal. This value, multiplied by 0.3 usec, yields a pulse width of 1.23 milliseconds and a duty cycle of 1.23 divided by 19.66 or 6.25%. The PCA may also allow setting of a start time which can be used to adjust the period of the PWM signal. For example, if the user desired a 100 Hz period, the user can configure the PCA to load a start value such that the PCA frame equals 1/100 Hz or 10 ms. This is accomplished by setting the start value of the PCA at 07DCAH where the count time to overflow from this value is 10.0 msec. The start value and compare value are loaded into the PCA at each counter overflow, i.e., at 10 msec intervals.

Servo motors 101A-B, 102A-B, 103A-B, and 104A-B are shown coupled to their respective control vanes: surface A and surface B of control pairs 101-104. Each servo's respective PWM signal line is output from one of PCAs 204a-b and fed through a respective buffer 201a-h. The buffers 201a-h serve to route the PWM signals to the servos and at the same time eliminate impedance that results from the PWM signal line driving the servo. Microcontroller 202a preferably controls half of the servo motors corresponding to control vanes while microcontroller 202b controls the other half. Each microcontroller controls one vane in each of the pairs. In this manner, if one microcontroller fails, the offside microcontroller can still control one control vane in each pair and thus keep a state of control over the vehicle, albeit a degraded one.

Microcontrollers 202a-b preferably contain analog-to-digital converters (ADCs) 206a-b and digital-to-analog converters (DACs) 208a-b such as those commonly known in the art. Multiplexers (MUXs) 210a-b, such as those commonly known in the art, are shown coupled to ADCs 206a-b. MUXs 210a-b are used to select which of multiple input lines are fed into ADCs 206a-b.

Microcontrollers 202a-b preferably contain at least one digital input (DI) 218a-b, and at least one digital output (DO) 220a-b. Interrupts 216a-b are also considered a DI.

In addition to digital communication ports 218a-b and 220a-b, microcontrollers 202a-b preferably contain serial communication ports Serial Tx 212a-b and Serial Rx 214a-b.

Analog servo position signals 203a-h are fed through filters and coupled to switch 220. Signal lines 205 and 207a-b comprise 8 signal lines each, though shown as a single line for simplicity. Switch 220 is operable to couple signal lines 207a-b to either signal line 205 or the output of DAC 208a-b depending on the output of AND gate 222.

Switch 222 is operable to couple Serial Rx ports 214a-b to either a corresponding flight control computer serial input channel or the offside microcontroller's Serial Tx port: one of 212a-b.

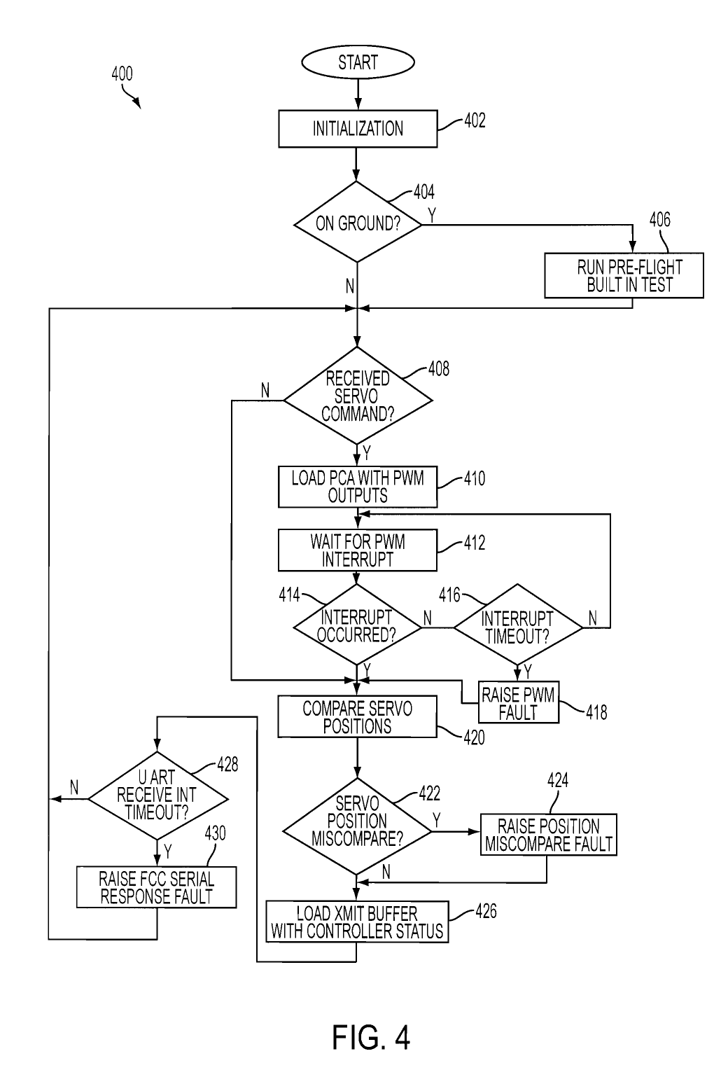

An exemplary method of control will now be described with reference to FIG. 2 and FIG. 4. The following method may be described with respect to a singular microcontroller. But it should be noted that an identical method takes place in each microcontroller of the smart servo controller as well as in the smart servo controller as a whole.

In FIG. 4, the method 400 begins at step 402 by initializing the microcontrollers 202a-b. This step simply resets pertinent registers, flashes the RAM, and sets all outputs to zero. The method continues at step 404 where the microcontrollers check DIs 218a-b for whether the vehicle is on the ground. If it is determined that the vehicle is on the ground the method continues with the pre-flight built in test (PFBIT) method 406.

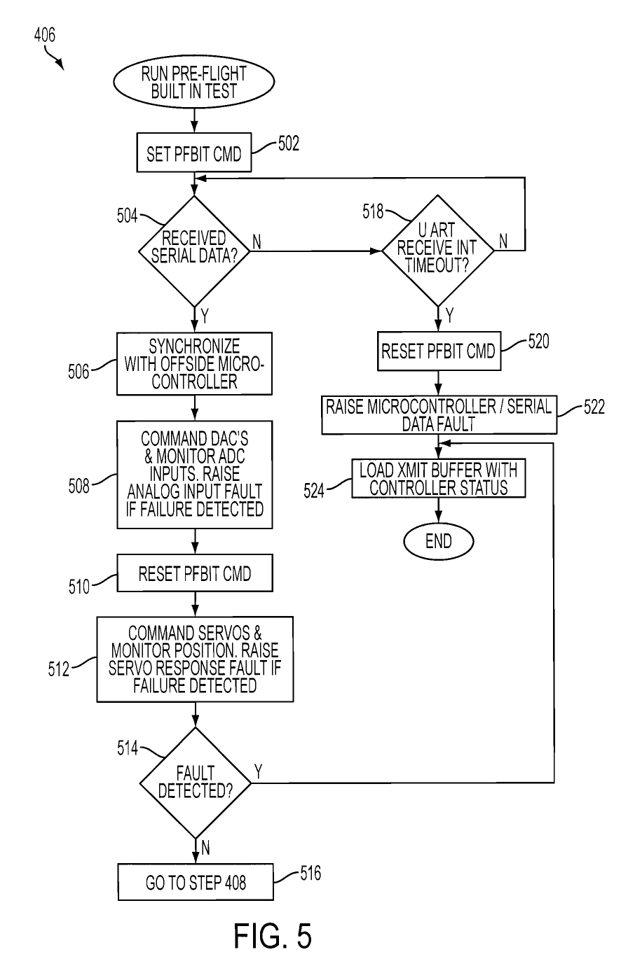

FIG. 5 illustrates an exemplary pre-flight built in test method 406. The method begins at step 502 by asserting the PFBIT signal line, the output of each DO 220a-b. DOs 220a-b are routed through AND gate 226; when both DOs 220a-b are asserted, the output of AND gate 222 is asserted. This actuates the switch 220 to couple ADC 206a to DAC 208a and to couple ADC 206b to DAC 208b. This is known as a wraparound and serves to calibrate the analog-to-digital and digital-to-analog converters of each microcontroller in step 506.

The assertion of the output of AND gate 226 also actuates switch 222 to wraparound Serial Rx port 214a to offside Serial Tx port 212b. Switch 222 also actuates to wraparound Serial Rx port 214b to offside Serial Tx port 212a. Microcontroller 202a can now communicate serially with its offside microcontroller 202b. At step 504, each microcontroller determines whether serial data has been received from the offside microcontroller. If no serial data has been received, the method continues at step 518 where the microcontroller checks if the Universal Asynchronous Receiver Transmitter (UART) interrupt timeout has occurred. The UART is part of each microcontroller and generates an interrupt when a serial communication is received. The UART waits a certain period for the interrupt before a timeout occurs. If a timeout occurs, the interrupt has not occurred and thus a communication has not been received.

If it is determined at step 518 that a timeout has occurred, the method proceeds to step 520 where the PFBIT (logic output of DOs 220a-b) is deasserted (i.e. brought to a logic low). A deasserted PFBIT signal line deasserts the output of AND gate 226, thus actuating switch 220 to couple servo position filter line 205 to ADCs 206a-b. A deasserted AND gate 226 also actuates switch 222 to couple serial channels 1 and 2 of the FCC to Serial Rx ports 214a and 214b respectively.

Next, at step 522 a microcontroller/serial data fault is raised by loading a status register with a code indicating the fault. This register is then transferred to the transmit buffer at step 524 and sent to the FCC through Serial Tx port 212a or 212b (whichever microcontroller generated the fault). The FCC could then take an action such as alerting a ground operator of the fault.

Referring back to step 504, if the determination is that the microcontroller has received serial data from the offside microcontroller, then the method continues at step 506 where the serial communication settings are synchronized. Next, at step 508 the microcontrollers output an analog signal from the DACs 208a-b and monitor the input of ADCs 206a-b. Since signal lines 207a-b comprise eight distinct signal lines (because there are eight servo motors) the same analog signal from DACs 208a-b is appropriately applied to each signal line of the eight through the switch 220 and selected for input by MUXs 210a-b. If no analog signal is detected at one of ADCs 206a-b, the appropriate microcontroller raises an analog input fault by loading a status register with a code indicating the fault. The method continues at step 510 where the PFBIT is deasserted, thus coupling each ADC 206a-b to the servo position signal lines and coupling each Serial Rx port 214a-b to its respective FCC serial channel communication line.

At step 512, the FCC sends a servo test command through serial channel 1 to Serial Rx port 214a and a servo command through serial channel 2 to Serial Rx port 214b. Each microcontroller reads the command and generates an appropriately sized PWM to output from the PCA in order to position each servo shaft in accordance with the FCC's command. Each ADC 206a-b is continuously monitoring the actual positions of each servo through signal lines 205 and 207a-b. If the actual position of servo shaft is not substantially the same as the position that the FCC commanded the servo to be in, the microcontroller will raise a servo response fault.

Next at step 514, if the status register indicates a fault has been raised the method proceeds to step 524 where the transmit buffer is loaded with the controller status, the buffer is sent to the FCC and the method ends. If, however, at step 514 the status register indicates that no fault has been raised, the pre-flight built in test concludes successfully and method 400 continues at step 408.

Step 408 begins with a determination of whether a servo command has been received at each microcontroller from the FCC. If it is determined that a command has been received in one or both of the microcontrollers, then at step 410 the respective microcontroller configures the PCA to output appropriate PWM signals to command the servos to the desired positions. At steps 412 the microcontroller waits for an interrupt to be generated at the interrupt port 216a or 216b. For example, an interrupt is generated in microcontroller 202b if each signal coming from PCA 204a of microcontroller 202a is asserted at substantially the same time. This results from passing each PWM signal from PCA 204a through AND gate 224a. If all of the signals are asserted at substantially the same time, the output of AND gate 224a will be asserted and thus generate an interrupt at port 216b. If interrupts are generated at both ports 216a-b then the microcontrollers can affirmatively determine that each PWM signal reached its respective servo successfully, and the method can continue to step 420.

If, however, a microcontroller fails or one or more PWM signal lines fail, no interrupt will be generated in the offside microcontroller. Step 414 will determine that no interrupt has occurred, proceed to step 416, and wait for the timeout. Once the timeout occurs and no interrupt has been generated, the microcontroller will raise a PWM fault. The method proceeds then to step 420 where the servo positions are compared.

The ADC 206a-b of each microcontroller reads in analog values of each servo position from signal lines 207a-b. If it is determined at step 422 that servos from the same pair are not in substantially the same position (or in respective, pre-determined positions), the microcontroller will raise a position miscompare fault. This fault may include a code that indicates which pair and/or which vanes are out of position.

The method proceeds to step 426 where the transmit buffer is loaded with the controller status. The status may accordingly indicate that one or more faults occurred. The controller status may also indicate that no faults have occurred. At step 428 the buffer is sent to the FCC and the microcontroller determines if the UART has generated an interrupt. If a timeout occurs before an interrupt is generated, the microcontroller raises an FCC serial response fault and returns to step 408. If the interrupt is received, the method simply returns to step 408.

An exemplary FCC, though not described in detail in the present application, is preferably operable to take an appropriate action in response to determining that a fault has occurred. For example, the FCC may determine to land the vehicle in response to determining that a servo has malfunctioned. Similarly, the FCC may notify a human operator of the fault, the human operator may then make a flight decision. Other decisions could be made as well such as re-routing the flight pattern, continuing the mission, starting another mission, etc.

It should be understood that the various functions described above can be carried out by suitably arranged software, firmware, and hardware logic. By way of example, each microcontroller may include one or more processors, data storage, and program instructions stored in the data storage and executable by the one or more processors to carry out the functions described.

While certain features and embodiments of the present application have been described in detail herein, it is to be understood that the application encompasses all modifications and enhancements within the scope and spirit of the following claims. For example, the smart servo controller may comprise more than two microcontrollers without departing from the scope of the present invention. Further, aerial vehicles may contain mechanical control surfaces set out in more or less than 4 pairs. The mechanical control surfaces may not be set out in pairs, but instead: groups of 3 or more.

We claim:

1. A method for controlling an unmanned aerial vehicle, the method comprising:
for each of a first plurality of servo motors, applying an electrical signal operable to change an angular position of a corresponding servo motor shaft, the angular position of the servo motor shaft controlling a position of a unique one of a corresponding plurality of mechanical control surfaces;
monitoring the angular positions of each of a second plurality of servo motor shafts, wherein the second plurality is a subset of the first plurality, and wherein each mechanical control surface corresponding to each servo motor in the second plurality controls the vehicle with respect to a first axis;
monitoring the angular positions of each of a third plurality of servo motor shafts, wherein the third plurality is a subset of the first plurality, and wherein each mechanical control surface corresponding to each servo motor in the third plurality controls the vehicle with respect to a second axis;
determining whether each servo motor shaft in one of the second or third pluralities is not in substantially the same angular position; and upon determining that each servo motor shaft in one of the second or third pluralities is not in substantially the same angular position, signaling a fault.

2. The method of claim 1, wherein the electrical signal comprises a pulse width modulated (PWM) signal, and wherein changing a duty cycle of the PWM signal changes the angular position of the corresponding servo motor shaft.

3. The method of claim 2, further comprising determining whether the electrical signals applied to each of a fourth plurality of servo motors are asserted at substantially the same time, wherein each mechanical control surface corresponding to a servo motor in the fourth plurality of servo motors controls the vehicle with respect to a different axis.

4. The method of claim 3, further comprising:
upon determining that the electrical signals are asserted at substantially the same time, generating an interrupt in a microcontroller.

5. The method of claim 3, wherein determining whether the electrical signals applied to each of a fourth plurality of servo motors are asserted at substantially the same time comprises:
logically ANDing the electrical signals applied to each of the fourth plurality in an AND gate, and wherein if an output of the AND gate is asserted, generating an interrupt in a microcontroller.

6. The method of claim 1, wherein signaling a fault comprises notifying a flight control computer of a fault, the flight control computer responsively setting a flight plan.

7. The method of claim 6, wherein setting a flight plan comprises landing the unmanned vehicle.

8. The method of claim 6, wherein setting a flight plan comprises entering a state of degraded flight control.

9. A method for controlling an unmanned aerial vehicle, the method comprising:
for each of a first plurality of servo motors, applying a respective electrical signal operable to change an angular position of a corresponding servo motor shaft, the angular position of the servo motor shaft controlling a position of a unique one of a corresponding first plurality of mechanical control surfaces;
for each of a second plurality of servo motors, applying a respective electrical signal operable to change an angular position of a corresponding servo motor shaft, the angular position of the servo motor shaft controlling a position of a unique one of a corresponding second plurality of mechanical control surfaces;
determining whether the signals applied to the first plurality of servo motors are asserted at substantially the same time, and upon determining that the electrical signals applied to the first plurality of servo motors are asserted at substantially the same time, generating an interrupt in the second microcontroller;
determining whether the signals applied to the second plurality of servo motors are asserted at substantially the same time, and upon determining that the signals applied to the second plurality of servo motors are asserted at substantially the same time, generating an interrupt in the first microcontroller.

10. The method of claim 9, wherein the electrical signals applied to the first and second pluralities of servo motors comprise pulse width modulated (PWM) signals, and wherein changing a duty cycle of the PWM signal changes the angular position of the corresponding servo motor shaft.

11. The method of claim 9, wherein the electrical signals applied to the first plurality of servo motors are generated in a first microcontroller and the electrical signals applied to the second plurality of servo motors are generated in a second microcontroller.

12. The method of claim 11, wherein making the first determination comprises logically ANDing the electrical signals applied to the first plurality of servo motors in a first AND gate, and wherein if an output of the first AND gate is asserted, generating an interrupt in the second microcontroller; and
wherein making the second determination comprises logically ANDing the electrical signals applied to the second plurality of servo motors in a second AND gate, and wherein if an output of the second AND gate is asserted, generating an interrupt in the first microcontroller.

13. The method of claim 9, further comprising monitoring the angular positions of each servo motor shaft in a third plurality of servo motors, wherein the third plurality is a subset of the first and second pluralities, and wherein the mechanical control surface that corresponds to each servo motor in the third plurality controls the vehicle with respect to a first axis.

14. The method of claim 13, further comprising:
if it is determined that each servo motor shaft in the third plurality of servo motors is not in substantially the same position, notifying a flight control computer, the flight control computer responsively setting a flight plan.

15. An unmanned aerial vehicle comprising:
a plurality of mechanical control surfaces; and
a servo controller comprising:
a first microcontroller for controlling a first plurality of servo motors, each servo motor having a shaft, wherein an angular position of the shaft corresponds to a position of a unique one of a first subset of the plurality of mechanical control surfaces, and wherein each mechanical control surface of the first subset controls the vehicle with respect to a different respective axis;
a second microcontroller for controlling a second plurality of servo motors, each servo motor having a shaft, wherein an angular position of the shaft corresponds to a position of a unique one of a second subset of the plurality of mechanical control surfaces, and wherein each mechanical control surface of the second subset controls the vehicle with respect to a different respective axis.

16. The unmanned aerial vehicle of claim 15, wherein the servo controller further comprises:
program logic associated with the first microcontroller executable to uniquely apply each of a first plurality of electrical signals to a respective one of the first plurality of servo motors;
program logic associated with the second microcontroller executable to uniquely apply each of a second plurality of electrical signals to a respective one of the second plurality of servo motors; and
program logic executable (i) to determine whether the first plurality of electrical signals are asserted at substantially the same time, (ii) to determine whether the second plurality of electrical signals are asserted at substantially the same time, (iii) to generate an interrupt in the second microcontroller upon determining that the first plurality of electrical signals are asserted at substantially the same time, and (iv) to generate an interrupt in the first microcontroller upon determining that the second plurality of electrical signals are asserted at substantially the same time.

17. The unmanned aerial vehicle of claim 15, wherein the servo controller further comprises:
program logic executable:
(i) to compare the angular positions of servo motor shafts that correspond to mechanical control surfaces that comprise a third subset of the plurality of mechanical control surfaces, wherein each mechanical control surface in the third subset controls the vehicle with respect to the same axis, and
(ii) to signal a fault upon determining that the angular positions of the servo motor shafts corresponding to mechanical control surfaces of the third subset are not in substantially the same position.

18. The unmanned aerial vehicle of claim 17, wherein logic executable to signal a fault comprises logic executable to notify a flight control computer of a fault, wherein the flight control computer sets a flight plan in response to the notification of the fault.

19. The unmanned aerial vehicle of claim 18, wherein the flight plan includes landing or entering a state of degraded control.
